(19) United States
(12) Patent Application Publication
(10) Pub. No.: US 2011/0258998 A1
(43) Pub. Date: Oct. 27, 2011

(54) DEVICE FOR A WINCH-OPERATED WAVE-POWER PLANT

(75) Inventors: Ingvald Straume, Ottestad (NO); Sivert Straume, Bergen (NO)

(73) Assignee: STRAUMEKRAFT AS, Oslo (NO)

(21) Appl. No.: 13/124,592

(22) PCT Filed: Oct. 12, 2009
(86) PCT No.: PCT/NO2009/000356

§ 371 Date: Jul. 8, 2011

(30) Foreign Application Priority Data
Oct. 17, 2008 (NO) 20084377

(51) Int. Cl. F03B 13/18

(52) U.S. Cl. 60/504

(57) ABSTRACT

A device for a winch-operated wave-power plant with a self-tightening winch connecting a wave-energy-absorbing body via a winch wire to a reference point. A winch cable drum is connected via a mechanical energy absorption- and conversion system to a rotating outgoing axle. The mechanical energy absorption- and conversion system is connected to a slip clutch. The slip clutch is arranged between the winch axle and the outgoing axle. The slip clutch can be set to slip, thereby reducing the flow of mechanical rotational energy from the rotating winch through the mechanical energy absorption- and conversion system, so that the amount of energy per time unit absorbed by the mechanical energy absorption- and conversion system is limited by how much the slip clutch slips. The system further includes a governing system controlling the slip clutch by acting upon excessive speed and/or forces in the winch and the winch axle.

### BACKGROUND OF THE INVENTION

In the patent literature over 1000 devices are described for converting the energy of ocean-waves into useful energy. Several wave-energy concepts, based on different technological approaches, have been presented. What has not been appreciated in these earlier concepts is that a successful commercial exploitation of energy from ocean waves requires the plants to have one (or more) inherent or ancillary overload protection mechanism(s). To become economically viable, the plants have to have some strategy for tackling the encounter with the most extreme waves. In essence the plants must interact differently with extreme waves than with average size and smaller waves. In average size and smaller waves, a plant should try to absorb as much energy as possible from the waves, to maximize its energy production. But in an extreme wave, it should behave differently to avoid absorbing the excessive energy from that wave, because that energy could damage the plant or its power conversion machinery if conducted into it. This allows wider application of the wave energy to different ocean environments, while keeping the design costs and maintenance costs down.

The invention described herein comprises a winch-operated wave-power plant with a floating buoy which absorbs energy from ocean waves, and a self-tightening winch, mounted on or otherwise connected to the buoy. Energy from the waves is absorbed by the winch and a power-take-off system connected to it. The system comprises an overload protection strategy based on the simple principle of not letting more energy into the system than the system itself can handle. This is made possible by a slip-clutch allowing the winch to wind out without offering increased resistance in events of violent waves, so that the buoy easily can be lifted on top of the violent waves and move along with the wave, instead of being buried in the waves and exposed to the extreme hydrodynamic forces that then would arise.

The device according to the invention comprises the following elements and subsystems, some of which are, separately, known and based on available technology:
A floating buoy 1 which absorbs wave energy
A self-tightening winch 2
A wire 3 interconnecting the buoy and the winch
A mechanical energy absorption- and conversion system 10 connected to the winch, which converts the mechanical energy absorbed from the buoy via the winch wire and the rotating winch, into useful energy
An overload-protecting slip clutch 6 which slips when the energy per time unit transferred through the winch axle reaches a certain level

The system assembly has certain characteristics, which the parts and subsystems do not have independently.

Individually these elements are not capable of solving the problem addressed by the invention described herein: to exploit energy from ocean waves with sufficiently low cost design of the plants without the plants and the components therein being destroyed by extreme waves.

A combination of the elements, as described in this document and according to the patent claims, will offer a substantial cost reduction for the plants, and is believed to involve a technical-commercial breakthrough for wave power as energy supply. The key point is that when the various elements are put together in this particular arrangement, the parts and subsystems together make up the fundamental basics of a wave energy absorption and conversion system that can and will survive extreme waves without expensive dimensioning requirements.

Some known descriptions of wave energy systems have however elements that can be confused with elements of the invention described herein, but without providing the same functional advantages when it comes to survivability and cost efficiency.

### Winch-Operated Wave-Power Plants

There are several examples of wave-power systems based on wave energy absorbing floating buoys, where energy is transmitted mechanically, by means of a wire rolling on a drum. See, e.g. U.S. 2005/0121915 and GR 990100030. However, these lack the overload-protection means which are necessary to allow the plants to survive the encounter with the most extreme waves in the worst stormy conditions without requiring having such a robust design that they become unprofitable.

U.S. Pat. No. 4,228,360 regards a wave motion apparatus with a winch, comprising a clutch (70) in the transfer system between the winch drum (12) and an energy storage system. The energy storage system comprises a flywheel (50) which is further connected to a generator. The flywheel is further connected to a flywheel governor (80) for controlling a clutch control (82). The clutch control causes the clutch to disengage when the rotational speed of the flywheel exceeds a threshold determined by the flywheel governor.

U.S. Pat. No. 6,617,705 describes a system in which the movement of the floating element is dampened when the wave speed is too high, i.e. the system regulates a brake, not a clutch.

U.S. 2008/217921 and WO 96/30646 regards wave power plants.

### Slip Clutch(es)

The principle of overload protection provided by the device according to the invention is about limiting power through-put by simply “letting go” and not absorbing more energy from the waves when maximum power input limit has been reached, so that the amount of energy conducted into the system never will become excessive. This fundamental principle has never elsewhere been described as part of a winch-anchored buoy-based ocean wave power absorption- and power conversion system's survivability strategy in extreme waves.

### SUMMARY OF INVENTION

To execute this principle in practice, the invention described herein comprises a slip clutch 6 between the winch 2 and the outgoing axle 8 from the mechanical energy absorption- and conversion system 10. In one embodiment this slip clutch is engaged and disengaged by built-in electromagnets governed by a computer. The computer is programmed to disengage the slip clutch when the amount of energy per time unit transferred from the buoy 1 via the wire 3 and the winch 2 through the winch axle 4 has reached a certain upper limit defined by the computer. The computer determines this upper limit by continuously performing calculations based on measurements of parameters such as: the strength of the force from the buoy 1 acting upon the wire 3, the torque on winch axle 4, and the rotational speed of the system.

The use of slip clutches in wave-power plants is mentioned in DE 2850293, WO 96/30646 and U.S. Pat. No. 4,228,360. But these lack the necessary characteristics in order for a wave-power plant, without incurring unreasonably large design costs, to be capable of surviving the encounter with the at times extreme forces of the ocean waves in the event of storms and hurricanes.

### BRIEF DESCRIPTION OF DRAWINGS

The invention will now be described in more detail by means of examples of embodiments and with reference to the accompanying figures.

FIG. 1 shows the winch with the mechanical energy absorption- and conversion system.

FIG. 2 shows one embodiment of the invention, with the buoy 1 connected to a mooring structure 9 on the seabed, and where the winch and the mechanical energy absorption- and conversion system machinery is located inside of the buoy.

### DETAILED DESCRIPTION

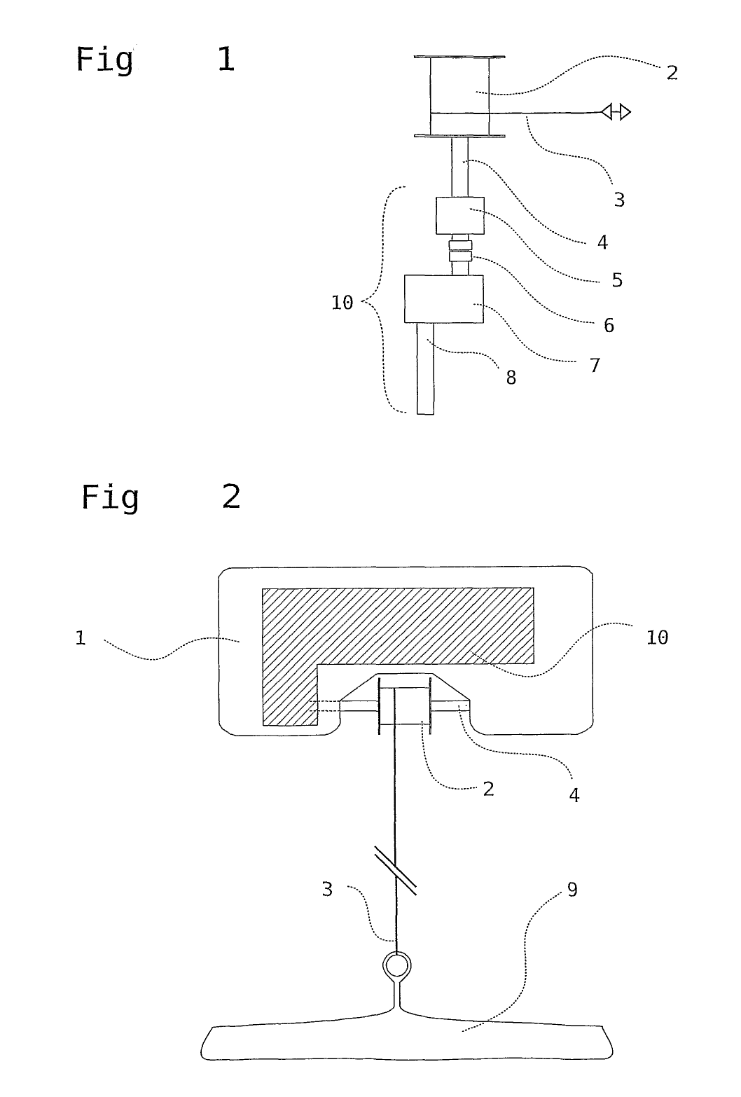

The device according to the invention comprises a wave energy absorbing floating buoy with energy absorption- and conversion system, which may be placed inside the buoy, on the sea floor or elsewhere. FIGS. 1 and 2 illustrate the principle of the device according to the invention. A floating buoy 1 acts as absorption element. This buoy is connected to a winch 2 with a winch wire 3. The buoy 1 and the winch 2 with the winch wire 3 are connected in such a manner that the winch is forced to rotate when the wave forces move the buoy 1 in the winch wire's longitudinal direction. The winch and the winch wire interconnect the buoy and a reference body below the waves of the ocean surface. This reference body may be a pelagic anchor plate, an anchor 9 at the seabed as shown in FIG. 2, an expansion bolt in the rock of the seabed, or a different anchoring device. In the embodiment shown in FIG. 2, the winch and the energy absorption- and conversion system is in the buoy. But those elements may also, instead of being integrated in the buoy, be placed elsewhere, for example at the seabed or in a pelagic anchoring device. The energy absorbed from the waves when the winch is forced to rotate, is transmitted in the form of rotating motion from the winch axle 4 to a mechanical energy absorption- and conversion system 10, ending in a high speed rotating axle 8. From this axle, the energy may be converted further into other forms, and eventually into electric power, by methods well known to engineers. Methods for converting the energy output from the fast rotating axle 8 into other forms of useful energy and into electricity, are not issues of this patent application, and are therefore not described.

The winch is self-tightening. This means that it spools in by itself when the wave forces that moved the buoy 1 and pulled out the winch wire 3, drops sufficiently. The self-tightening functionality of the winch may be achieved by mechanical, hydraulic or electric powered means, well known to mechanical engineers, and is therefore not further described in this text.

### The Mechanical Energy Absorption- and Conversion System

Inside the mechanical energy absorption- and conversion system 10, rotational energy is transferred from the winch axle 4 to a outgoing axle 8. In this document, the axle 8 is referred to as a high speed rotating axle, because in the preferred embodiment of the invention, the mechanical energy absorption- and conversion system contains one or more gears 5, 7 gearing up the rotational speed so that the axle 8 rotates faster than the winch axle 4. These gears are, however, optional. The functionality of the system is to capture rotational energy from the winch and transfer that rotational energy to the outgoing axle 8, from where it can be converted further into useful energy.

### Overload Protection Philosophy

The fundamental principle for protecting the wave power plant, and the parts and subsystems contained in it, against overload, is simple: When the amount of wave energy per time unit which encounters the buoy is excessive, the buoy simply does not absorb that energy. This is made possible by designing an energy conversion and absorption system which inherently limits the amount of energy per time unit that can be channelled into the system. The idea is that the wave-power plant should be capable of withstanding the worst extreme waves because it does not try to resist the waves when the wave forces therein become too great, but instead gives way and allows most of the power in the extreme waves, the destructive energy peaks, to pass and remain in the sea.

### Overload-Protecting Slip Clutch

The speed and forces and the rotational torques which the mechanical energy absorption- and conversion subsystem 10 and the components in it will be exposed to caused by the wave motions, can be limited by an overload-protecting slip clutch 6 mounted inside the mechanical energy absorption- and conversion system 10, or between the winch axle 4 and the mechanical energy absorption- and conversion system.

In order to avoid excessive speeds in the system, the mechanical slip clutch 5 may be set to slip if the speed of the winch exceeds a predefined threshold value. Or the slip clutch may be set to slip if the rotational torque of the winch axle becomes excessive. Also: the slip clutch may be set to slip if other conditions are met, such as if the force applied to the wire gets too high. One or more governing systems can regulate the pressure force inside the slip clutch, thereby determining when and when not the slip clutch should slip. Such governing systems may be of mechanical nature, like the famous centrifugal governor that James Watt used in his epoch-making steam engine. Or they may be made up of equivalently acting hydraulic components. But with today's technology, the preferred choice would be having an electronic system govern the slip clutch's behaviour.

The slip clutch may be designed with electromagnets mounted onto it, which can be activated and deactivated, and whose magnetic strength can be varied, thereby regulating the pressure force of the slip clutch. These variable electromagnets arrange for the compressive force in the clutch to be adjusted according to the signals from a computer. The slip clutch may in addition have a built-in mechanical spring ensuring a minimum mechanical compressive force in the clutch in events of failure of the electromagnets or the system governing it. The electromagnets can reinforce the effect of the built-in mechanical spring, enabling the slip clutch to transfer a higher torque. They can also work in the opposite direction, by counteracting the force of the built-in mechanical spring. The counteracting forces that may be produced by these electromagnets are strong enough to completely offset the force from the built-in mechanical spring, so that the slip clutch may completely disengage. The pressure force from the built-in mechanical spring, alone, without reinforcement from the electromagnets, should be sufficiently low to ensure that the slip clutch slips in events of rapid motions of the buoy and the winch wire caused by the most extreme waves.

Electronic sensors in connection with the corresponding parts of the mechanical energy absorption- and conversion system continuously measure the state of different physical quantities of the system and individual components in the system, where one or more of the following parameters are essential:
the rotational speed of the winch 2 or the winch axle 4
the torque of the winch axle 4
the force applied to the winch wire 3 or the winch 2 from the wave energy absorbing buoy 1

Measurement data from the sensors are instantly sent to the computer. The computer controls the electromagnets in the slip clutch. The computer is programmed to calculate the flow of power (energy per time unit) which is channelled into the system at any time, based on these input data, and to disengage the slip clutch 16 when needed, and to reengage it when favourable, to protect the internal system from excessive speed, excessive forces and excessive energy input. The computer may for example be programmed to disengage the slip clutch when the rotational speed of the winch 2 exceeds a certain predefined threshold value A, and regardless of rotational speed when the torque inside the winch axle 4 exceeds a predefined threshold value B. The computer may in addition for example be programmed to disengage the slip clutch when the rotational speed of the winch exceeds a predefined threshold value C, which is lower than A, and when the torque of the winch axle at the same time exceeds a value D which is lower than B. A number of other conditions for engagement and disengagement of the slip clutch may be programmed into the computer. The conditions for re-engaging the slip clutch need not be the exact inverse of the conditions for disengagement. If the slip clutch slips at a rotational speed value A, it may re-engage at a value E, which is lower than A or even zero.

Disengagement of the slip clutch may also depend on something other than flow of power, force, torque or rotating speed on the winch or the rotating elements associated with it. For example: disengagement may be controlled manually or by a remote control computer system. Manual or remote computer controlled disengagement of the slip clutch may be executed e.g. in storm episodes or based on weather forecasts that warns of bad weather. The computer may also be programmed to recognize certain characteristics or patterns of input measurement data as an upcoming storm or upcoming high waves, and act upon that. Or disengagement may be executed when the temperature in critical parts of the system rises above a certain level.

1. A device for a winch-operated wave-power plant with a self-tightening winch connecting a wave-energy-absorbing body via a winch wire to a seabed or to another reference point,
wherein a winch cable drum is connected via a mechanical energy absorption- and conversion system to a rotating outgoing axle,
wherein the mechanical energy absorption- and conversion system is connected to a slip clutch,
wherein the slip clutch is arranged between the winch axle and the outgoing axle,
wherein the slip clutch can be set to slip, thereby intercepting or reducing the flow of mechanical rotational energy from the rotating winch through the mechanical energy absorption- and conversion system, so that the amount of energy per time unit absorbed by the mechanical energy absorption- and conversion system is limited by how much the slip clutch slips,
wherein the system further comprises a governing system controlling the slip clutch by acting upon excessive speed and forces in the winch and the winch axle.

2. A device according to claim 1, wherein the governing system is adapted to control the slip clutch to disengage when the rotational speed of the winch and the winch axle exceeds a certain predefined threshold value.

3. A device according to claim 1, wherein the governing system is adapted to control the slip clutch to disengage when one of the torque inside the winch axle and the force acting from the wave-energy absorbing body on the winch wire and the force acting from the wave-energy absorbing body on the winch exceeds a certain predefined threshold value.

4. A device according to claim 1, wherein the slip clutch can be engaged or disengaged by magnetic forces from built in electromagnets,
wherein the strength and direction of the electromagnets are controlled by a computer which determines when to engage and disengage the slip clutch by performing calculations based on continuous input data covering different physical measuring parameters of the system and its individual components,
wherein force on the winch wire, torque on the winch axle, and rotational speed of the winch axle are essential, so that the slip clutch may be disengaged when needed, cutting or lessening the flow of mechanical power from the winch to the outgoing axle, to protect the wave power plant and its components from damaging interaction from extreme waves, and re-engaged when the rotational speeds of the clutch's input shaft and output shaft are equal or zero.

5. A device according to claim 1 where the mechanical energy absorption- and conversion subsystem contains a gear transmission system between the winch cable drum and the slip clutch gearing up the rotational speed of the slip clutch.

6. A device according to claim 1, wherein the mechanical energy absorption- and conversion system contains a gear transmission system between the slip clutch and the outgoing axle, gearing up the rotational speed so that the outgoing axle may rotate faster than the slip clutch.

7. A device according claim 1, wherein the computer controlling the varying engagement, disengagement and re-engagement of the slip clutch can be programmed to act based on calculations made from one of measuring temperature in various parts of the system, measuring flow of energy through the system, and statistical input measurement data that can be interpreted as alerts of one of a coming storm and that excessively high waves are coming.

8. A device according to claim 1, wherein the slip clutch is arranged to be controlled manually.

9. A device according to claim 1, wherein the slip clutch is arranged to be controlled by remote control.
